(19) United States
(12) Patent Application Publication
(10) Pub. No.: US 2008/0093848 A1
(43) Pub. Date: Apr. 24, 2008

(54) Flanged pipe coupling

(76) Inventors: James M. Truitt, Claremore, OK (US); Jack Powers, Catoosa, OK (US)

Correspondence Address: William S. Dorman, Suite 400, 406 South Boulder, Tulsa, OK, 74103, US

(21) Appl. No.: 12/002,125

(22) Filed: Dec. 17, 2007

Related U.S. Application Data
(63) Continuation-in-part of application No. 11/518,629, filed on Sep. 11, 2006.

(51) Int. Cl. F16L 13/00

(52) U.S. Cl. 285/405

(57) ABSTRACT

A flanged pipe coupling for connecting together two pieces of pipe, the coupling having a flat circular flange having an upper surface and a lower surface, the flanged pipe coupling further having a cylindrical portion of lesser outer diameter than that of the circular flange and extending upwardly from the upper surface of the circular flange, the outer diameter of the cylindrical portion being preferably less than the diameter of the hole through the floor, the cylindrical portion having an upper end with a first bore therein for receiving a first pipe therein, the cylindrical portion having an lower end with a second bore therein for receiving a second pipe therein, the cylindrical portion being provided with an internal flange projecting inwardly between the bores and having an internal diameter less than the outer diameter of the pipes to be connected together.

### CROSS-REFERENCE TO RELATED APPLICATION

This application is a continuation in part of prior application Ser. No. 11/518,629, filed Sep. 11, 2006, in the name of James M. Truitt, entitled Lip Coupling.

### BACKGROUND OF THE INVENTION

1. Field of the Invention

The present invention relates to a device for coupling together two pieces of pipe whose intended point of connection to each other is at or adjacent a floor or wall. More particularly, the coupling of the present invention is provided with a cylindrical section which connects with an outwardly extending circular flange which is relatively thin and which is at right angles to the cylindrical body.

2. Prior Art

The prior art is replete with examples of couplings for pipes wherein the couplings are embedded in or become part of the floor. However, no prior art coupling exists today where a flat flanged portion thereof is adapted to overly a hole in the floor or a wall to support the coupling on the floor or against the wall.

Harbeke U.S. Pat. No. 4,619,471 (FIGS. 2 and 5) shows a coupling having an internal flange constituting a ridge stop for separating two pieces of pipe fitted together within a coupling. So also does the disclosure of the above mentioned prior co-pending application. However, the art does not show the coupling having a flat, disk-like, flange extending at right angles to a cylindrical body and adapted to bear against the side of a wall or on a floor while, at the same time, coupling together two pieces of pipe.

### SUMMARY OF THE INVENTION

The present invention provides a flanged pipe coupling which is useful in connecting together two pieces of pipe adjacent a hole in the floor or adjacent a hole in the wall. The flanged pipe coupling is provided with a cylindrical portion of a diameter preferably somewhat smaller than the proposed hole which was going through the wall or the floor. The cylindrical portion connects at one end thereof with a flat circular flange which extends out from the cylindrical portion at right angles thereto and which exceeds the diameter of the proposed hole by a considerable amount. Midway between the upper end of the cylindrical portion and the lower end thereof will be an internal flange having an inner diameter less than the diameter of the pipes to be received in the coupling so that the pipe will come against this internal flange acting as stop

The flanged pipe coupling of the present invention can be made from a broad spectrum of pipe materials, with the most common being PVC or cast iron. The coupling may be made with a variety of configurations including male or female solvent weld joints for PVC pipes. The PVC fitting could be created with male threads or tapped threads and in varying sizes with the most common being one and one half and two inch.

There are several beneficial uses of the flanged pipe coupling in both new construction and remodeling. Unsightly holes created by pipe penetration through walls or floors can be completely covered with use of this fitting. Simultaneous continuance runs of pipe and fittings for connection to additional plumbing fixtures is an added benefit.

The conventional riser clamp that is being used today can be replaced with the use of the flanged pipe coupling. A self-supporting plumbing system is automatically achieved by placing the flanged pipe coupling in a drilled hole in either an existing concrete or wood floor. Also, current building codes require all penetrated holes in a multi-story building be fireproofed. With the flanged pipe coupling no fire proofing is required because all holes are completely covered.

A prime example of its use would be: A PVC flanged pipe coupling could have a pipe solvent welded into the bottom part of the coupling then placed in the hole or alternatively be secured to the floor, if needed. A solvent weld would be applied into the top part of the coupling for connection of additional pipe extending to the next floor. This can be repeated in a high rise or a two story building.

Labor savings can also be achieved with use of the flanged pipe coupling in a multi-story building. With the flanged pipe coupling having a section of pipe solvent welded into the bottom part of the coupling, then placed and secured in the hole. one plumber can work underneath while a second plumber on top can work at the same time. This is a beneficial cost savings by allowing two plumbers working off the same flanged pipe coupling.

The flanged pipe coupling is also beneficial for cleanliness when replacing drain waste piping in a structure that is built over a crawl space. The flanged pipe coupling can have the bottom part solvent welded with a piece of pipe, then placed in the hole that has been drilled. The top part of the flanged pipe coupling can be piped to hook up a sink in a vanity of from the floor before the workman accesses the crawl space. Whenever that part of the drain is completed the plumber can then access the crawl space to finish uncompleted work. This method keeps the worker clean which undoubtedly will be appreciated by the homeowner. previously, the workman would have to work in the crawl space first then complete the work above the floor.

### BRIEF DESCRIPTION OF THE DRAWINGS

FIG. 1 is perspective of the flanged pipe coupling of the present invention;

FIG. 2 is a side elevation of the flanged pipe coupling of FIG. 1, showing, in dotted lines, the internal flange which acts as a stop for two interconnecting pipes;

FIG. 3 is a plan view of the flanged pipe coupling of FIG. 1; and,

FIG. 4 is a cross-sectional view taken along section line 4-4 of FIG. 2 and showing the relationship between the flanged pipe coupling of the present invention and a section of floor, for example.

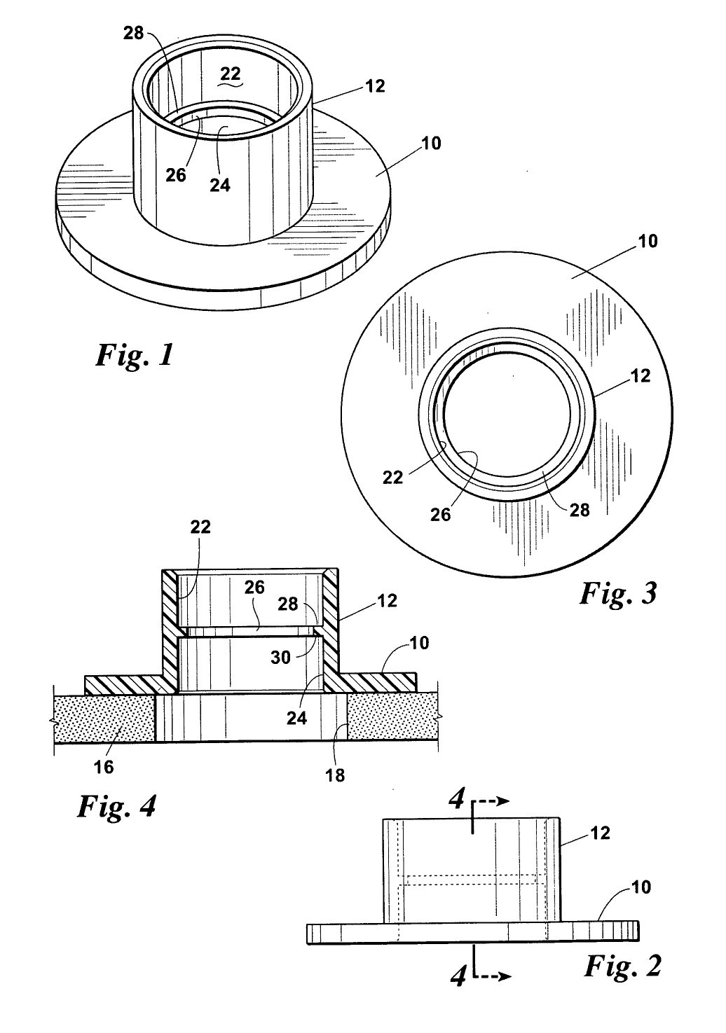

### DETAILED DESCRIPTION OF THE PREFERRED EMBODIMENTS

The present invention relates to a device for coupling together two pieces of pipe (preferably PVC pipe) above or below a floor. The coupling, which is preferably made of PVC, has a circular flat flange which can be used to cover a hole in the wall or in the floor. The flat flange 10 connects with a cylindrical portion 12 of lesser diameter than the diameter of the flange and which extends entirely to one side of the flange 10. The pipe coupling is best employed when the flat flanged portion 10 is disposed over flooring 16 (see FIG. 4) and over the hole 18 in the floor. It is contemplated that one piece of pipe will be inserted from beneath the floor 16 through the hole 18 and into a bore 24 forming the lower portion of the cylindrical portion 12. A second pipe (not shown) will be inserted into the cylinder from above and into a cylindrical bore 22 separated from the lower cylindrical bore 24 by means of an internal flange 26. The upper and lower surfaces of the internal flanged 26, where it projects outwardly from the inner bores 22 and 24, provide shoulders or stops 28 and 30 for the pipe (not shown) to be inserted into the bores 22 and 24.

Although the flanged pipe coupling of the present invention is perhaps most advantageously employed in connection with a floor 16 as shown in FIG. 4, principally because it covers completely the hole 18 which can not be observed by a person with the pipe coupling in the position shown; nevertheless, the flanged pipe coupling of the present invention can be also used in several additional different ways. It can be used, for example, where two pipes, horizontally arranged, are designed to go through a hole in a wall. In such case, the pipes are cut to proper lengths to extend from the fixtures involved to the flanged pipe coupling of the present invention. Therefore, when the flanged pipe coupling is placed over the pipe (not shown) designed to be received in the internal bore 24 it can be adjusted so that the flange 10 will abut the wall (not shown), and be secured thereto. It is further contemplated that the pipe coupling of the present invention can be used beneath the floor 16, in which case, it can be used to hide the hole 18 for people in the room below. Further, the flanged pipe coupling of the present invention can be inverted from the position shown in FIG. 4 and the cylindrical portion 12 inserted through the hole so that the upper side of the flange 10 as it appears in FIG. 4 will now be against the upper portion of the floor 16 on opposite sides of the hole. Finally, if one were to desire to insert the cylindrical portion 12 from below and through the hole 18 in the floor, this arrangement could be employed if desired.

What is claimed is:

1. A flanged pipe coupling for connecting together two pieces of pipe, one piece of pipe being designed to go through a hole in a floor or wall, the coupling having a flat circular flange having an upper surface and a lower surface, the flanged pipe coupling further having a cylindrical portion of lesser outer diameter than that of the circular flange and extending upwardly from the upper surface of the circular flange, the outer diameter of the cylindrical portion being preferably less than the diameter of the hole through the floor, the cylindrical portion having an upper end with a first bore therein for receiving a first pipe therein, the cylindrical portion having an lower end with a second bore therein for receiving a second pipe therein, the cylindrical portion being provided with an internal flange projecting inwardly between the bores and having an internal diameter less than the outer diameter of the pipes to be connected together.

2. A flanged pipe coupling as set forth in claim 1 wherein the portions of the internal flange above and below the flange where the latter connects with the internal bores are shoulders which constitutes stops for the pipes inserted into the bores.
